(19) United States
(12) Patent Application Publication
(10) Pub. No.: US 2026/0348030 A1
(43) Pub. Date: Nov. 5, 2026

(54) HIGH-ENTROPY RUTHENIUM-BASED OXIDE CATALYST FOR OXYGEN EVOLUTION REACTION (OER) IN ACIDIC MEDIA

(71) Applicant: Toyota Motor Engineering & Manufacturing North America, Inc., Plano, TX (US)

(72) Inventors: Li Qin Zhou, Okemos, MI (US); Siwen Wang, Livonia, MI (US); Chen Ling, Troy, MI (US)

(73) Assignees: Toyota Motor Engineering & Manufacturing North America, Inc., Plano, TX (US); Toyota Jidosha Kabushiki Kaisha, Aichi-ken (JP)

(21) Appl. No.: 19/196,948

(22) Filed: May 2, 2025

(51) Int. Cl. C25B 11/081; C25B 1/04; C25B 9/19; C25B 11/037

(52) U.S. Cl. CPC C25B 11/081; C25B 1/04; C25B 9/19; C25B 11/037

(57) ABSTRACT

Disclosed is an oxygen evolution reaction (OER) catalyst material comprising a quaternary ruthenium doped oxide of formula Ruₓ(CrNiTiCo)₁₋ₓO₂, wherein x is between 0.20-0.75. The quaternary ruthenium doped oxide crystallizes in a pure phase of tetragonal rutile-structure based on a RuO₂ crystal lattice. The quaternary-doped ruthenium oxide (RuO₂) catalyst materials of the present disclosure have improved stability as compared to undoped ruthenium oxide catalysts for oxygen evolution reactions (OER) in water electrolysis devices.

### TECHNICAL FIELD

The present disclosure generally relates to oxygen evolution reaction (OER) catalyst materials comprising quaternary-doped ruthenium-based oxide nanoparticles, proton exchange membrane systems, and water electrolysis devices employing oxygen evolution reaction (OER) catalyst materials.

### BACKGROUND

Water electrolysis (WE) using the hydrogen evolution reaction is widely recognized as a promising method for clean and sustainable hydrogen production. Currently, dominant alkaline-based water electrolysis encounters challenges including high ohmic resistance, limited current density, and low efficiency. Proton exchange membrane (PEM) electrolysis provides efficient proton transfers and can effectively tackle the above challenges. The sluggish oxygen evolution reaction (OER) in acid has been a major long-existing obstacle in PEM systems and has therefore attracted great research interest. Iridium oxide (IrO₂) is currently considered the only practical OER electrocatalyst in PEM devices due to its high activity and durability. However, the high cost and low global reserve of iridium (Ir) limit its large-scale applications. Less-expensive catalysts for OER in acidic media are in great demand.

Ruthenium dioxide (RuO₂) has been recognized as an attractive alternative to iridium dioxide (IrO₂) for acidic OER due to its lower cost (the price of ruthenium (Ru) is 1/10 of iridium (Ir) and earth abundance of ruthenium (Ru) is ~100X of iridium (Ir)). Ni, Cr, Ti and Co are much less expensive than rare earth dopants (for example, La³⁺, Pr³⁺, Nd³⁺, Sm³⁺and Gd³⁺). While RuO₂ presents higher OER activity than iridium dioxide (IrO₂), its long-term stability remains a challenge. In recent years, various strategies, i.e., lattice doping, strain effect, and morphology and structure modifications, have been tried to improve the performance of RuO₂ in acidic media. It would be desirable to improve stability of RuO₂ for acidic oxygen evolution reaction.

### SUMMARY

This section provides a general summary of the disclosure and is not a comprehensive disclosure of its full scope or all of its features. In various aspects, the present teachings provide an oxygen evolution reaction (OER) catalyst comprising a quaternary-doped ruthenium oxide of formula Ruₓ(CrNiTiCo)₁₋ₓO₂, wherein x is between 0.20-0.75. In some examples x is 0.75. In some examples, the quaternary-doped ruthenium oxide is Ru_{0.75}(CrNiTiCo)_{0.25}O₂. The quaternary-doped ruthenium oxide crystallizes in a pure phase of tetragonal rutile-structure based on a RuO₂ crystal lattice. The oxygen evolution reaction (OER) catalyst materials of the present disclosure are stable in acidic media. The quaternary-doped ruthenium oxide may comprise nanoparticles. The nanoparticles may have an average particle size of 2-10 nm.

In some aspects, the present teachings provide a water electrolyzer device comprising: an anode; a cathode; a proton exchange membrane disposed between the anode and cathode; an anode collector; and a cathode collector. The anode comprises an oxygen evolution reaction (OER) catalyst comprising an oxygen evolution reaction (OER) catalyst a quaternary-doped ruthenium oxide of formula Ruₓ(CrNiTiCo)₁₋ₓO₂, wherein x is between 0.20-0.75. In some examples x is 0.75. In some examples, the quaternary-doped ruthenium oxide is Ru_{0.75}(CrNiTiCo)_{0.25}O₂. The quaternary-doped ruthenium oxide crystallizes in a pure phase of tetragonal rutile-structure based on a RuO₂ crystal lattice. The oxygen evolution reaction (OER) catalyst materials of the present disclosure are stable in acidic media. The quaternary-doped ruthenium oxide may comprise nanoparticles. The nanoparticles may have an average particle size of 2-10 nm.

In other aspects, the present teachings provide a method for enhancing electrochemical stability of oxygen evolution reaction catalysts in acidic media comprising: providing an oxygen evolution reaction (OER) catalyst material to an anode of a water electrolyzer device, wherein the oxygen evolution reaction (OER) catalyst material comprises a quaternary ruthenium doped oxide of formula Ruₓ(CrNiTiCo)₁₋ₓO₂, wherein x is between 0.20-0.75. In some examples x is 0.75. In some examples, the quaternary-doped ruthenium oxide is Ru_{0.75}(CrNiTiCo)_{0.25}O₂. The quaternary-doped ruthenium oxide crystallizes in a pure phase of tetragonal rutile-structure based on a RuO₂ crystal lattice. The oxygen evolution reaction (OER) catalyst materials of the present disclosure are stable in acidic media. The quaternary-doped ruthenium oxide may comprise nanoparticles. The nanoparticles may have an average particle size of 2-10 nm.

Further areas of applicability and various methods of enhancing the above technology will become apparent from the description provided herein. The description and specific examples in this summary are intended for purposes of illustration only and are not intended to limit the scope of the present disclosure.

### BRIEF DESCRIPTION OF THE DRAWINGS

The present teachings will become more fully understood from the detailed description and the accompanying drawings wherein:

FIG. 1 is a schematic illustration of a water electrolyzer.

FIG. 2 illustrates a proton exchange membrane (PEM) electrolysis reaction in a water electrolyzer.

FIG. 3 provides the X-ray diffraction pattern of synthesized Ru_{0.75}(CrNiTiCo)_{0.25}O₂ along with the peaks from RuO₂ standard (PDF #04-009-8495) provided for comparison.

FIG. 4. is a bright field scanning transmission electron microscopy (STEM) image showing the crystallite structure of synthesized Ru_{0.75}(CrNiTiCo)_{0.25}O₂ (scale bar 5 nm).

FIG. 5 is a graphic illustration of linear sweep voltammetry (LSV) curves for synthesized undoped RuO₂ (broken line), and doped Ru_{0.75}(CrNiTiCo)_{0.25}O₂ (unbroken line) in reaction performed in 0.1 M perchloric acid (HClO₄).

FIG. 6 is a graphic illustration of chronopotentiometry (CP) stability tests for synthesized undoped RuO₂ (broken line), and doped Ru_{0.75}(CrNiTiCo)_{0.25}O₂ (unbroken line), in an oxygen evolution reaction performed in 0.1 M perchloric acid (HClO₄).

It should be noted that the figures set forth herein are intended to exemplify the general characteristics of the methods, algorithms, and devices among those of the present technology, for the purpose of the description of certain aspects. These figures may not precisely reflect the characteristics of any given aspect and are not necessarily intended to define or limit specific embodiments within the scope of this technology. Further, certain aspects may incorporate features from a combination of figures.

### DETAILED DESCRIPTION

The present teachings provide quaternary-doped ruthenium oxide (RuO₂) catalyst materials having improved stability as compared to undoped ruthenium oxide catalysts for oxygen evolution reactions (OER) in water electrolysis devices. In particular the present disclosure provides a chromium (Cr), nickel (Ni), titanium (Ti), and cobalt (Co) multi-element co-doped RuO₂ catalyst with improved stability for acidic oxygen evolution reactions (OER) in water electrolyzers.

Water electrolyzers are electrochemical devices designed to split water (H₂°) into hydrogen (H₂) and oxygen (O₂) gases using electricity. These gases can subsequently be utilized for energy storage purposes. This process, known as electrolysis, is critical for green hydrogen production. Proton exchange membrane (PEM) electrolysis involves the use of a PEM water electrolyzer cell equipped with a solid polymer electrolyte responsible for conducting protons, separating product gases, and electrically insulating the electrodes. In acidic media, the reaction occurs within proton exchange membrane (PEM) electrolyzers, following the overall process: H₂O→H₂+½O₂.

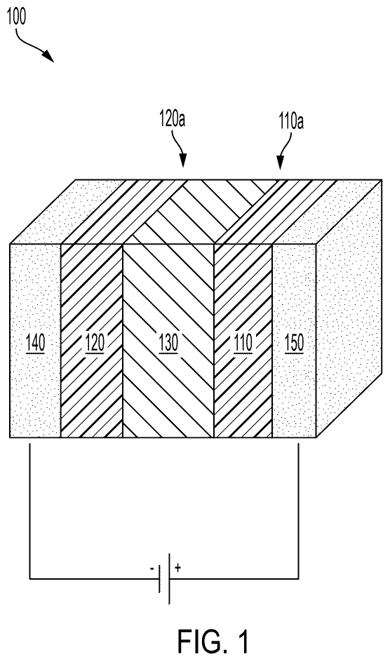

FIG. 1 illustrates a water electrolyzer 100 comprising an anode 110, a cathode 120, a proton exchange membrane (PEM) 130 between the anode 110 and the cathode 120. The electrolyzer further includes anode and cathode current collectors 150 and 140, respectively, which are connected to the negative and positive terminals of a power source. The anode 110, or oxygen-evolving electrode, may be composed of a noble metal oxide catalyst such as iridium oxide (IrO₂), ruthenium dioxide (RuO₂), or a mixed metal oxide suitable for acidic oxygen evolution reaction (OER) conditions. The cathode 120, or hydrogen-evolving electrode, may be made of a hydrogen evolution catalyst such as a platinum (Pt)-containing catalyst or catalyst containing platinum on a carbon support (Pt/C). The proton exchange membrane 130, may be composed of a solid polymer electrolyte configured to conduct protons (H⁺) from the anode to the cathode during operation, such as Nafion®, and is positioned between and interfaces with both the anode 110 and cathode 120 at anodic interface 110a and cathodic interface 120a, respectively. The solid polymer electrolyte comprising the proton exchange membrane 130 serves as the medium through which protons (H⁺) are transported from the anode to the cathode during water electrolysis. The cathodic interface 120a and the anodic interface 110a facilitate proton transport and electrochemical reactions that generate hydrogen gas at the cathode and oxygen gas at the anode. Cathodic and anodic current collectors 140 and 150, respectively, conduct the electrical current required to drive the electrochemical splitting of water.

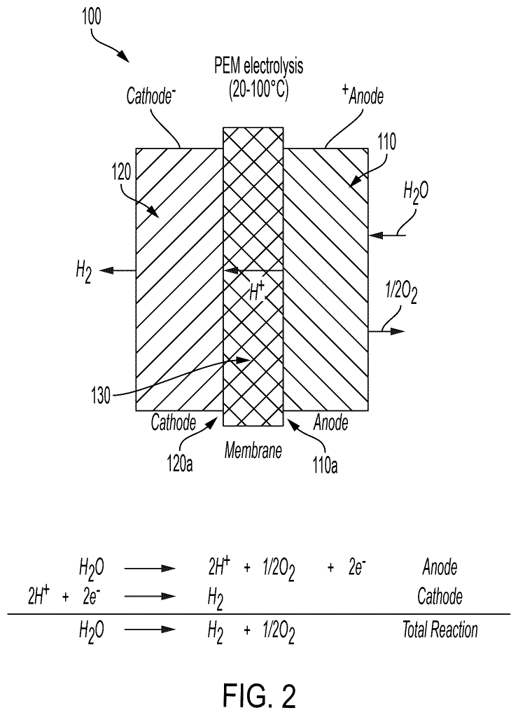

FIG. 2 illustrates the proton exchange membrane (PEM) water electrolysis reaction. The proton exchange membrane 130 is disposed between the anode 110, and the cathode 120. The oxygen evolution reaction (OER), occurring on the anode side of a PEM water electrolyzer, involves the oxidation of liquid water reactant supplied to the catalyst, resulting in the formation of oxygen, protons, and electrons: 2H₂O (liquid)→O₂ (gas)+4H⁺ (aqueous)+4e⁻. On the cathode side of a PEM water electrolyzer, the hydrogen evolution reaction (HER) takes place, where the supplied electrons and the protons conducted through the membrane combine to produce gaseous hydrogen: 2H⁺ (aqueous)+2e⁻→H₂ (gas). The overall reaction is: H₂O (liquid)→H₂ (gas) +½ O₂ (gas).

The present disclosure provides multi-element or high-entropy ruthenium-based oxide catalysts, comprising multiple metal cations stabilized by lattice doping, exhibiting enhanced catalytic performance and durability under acidic oxygen evolution reaction conditions. The term “multi-element” may be used interchangeably with multi-component and refers to multiple elements, such as multiple metal cations, incorporated into a single crystalline oxide lattice structure. “High-entropy” is used in the present disclosure to refer to materials that contain five (5) or more principal elements in equal atomic or nearly equal atomic ratios. The present disclosure relates to high-entropy ruthenium oxides which incorporate at least four (4) different metal cations into a single, stable crystalline oxide lattice of ruthenium. The present disclosure provides an oxygen evolution reaction (OER) catalyst material comprising a quaternary-doped ruthenium oxide of formula Ruₓ(CrNiTiCo)₁₋ₓO₂, wherein x is between 0.20-0.75. in some examples, x is 0.75. In some examples, the quaternary-doped ruthenium oxide is Ru_{0.75}(CrNiTiCo)_{0.25}O₂.

The multi-element or high-entropy ruthenium-based oxide catalysts of the present disclosure are single phase metal oxides. The term “single phase” refers to monophasic or pure phase wherein a crystalline material is composed of one single crystallographic phase, without any mixture of other phases, or impurities. In the multi-element ruthenium-based metal oxides of the present disclosure, the single phase is a tetragonal rutile phase, wherein the metal cation sites are occupied by a uniform distribution of five different metal elements forming a single-phase solid solution. Oxygen anions (O) are coordinated around the metal centers, forming distorted octahedral units typical of a rutile structure.

The quaternary-doped ruthenium oxide of the present disclosure crystallizes in a pure phase of tetragonal rutile-structure based on a RuO₂ crystal lattice.

The quaternary-doped ruthenium oxide of the present disclosure is stable in acidic media. The nanoparticles of the present disclosure have an average particle size of less than 10 nm, less than 5 nm, or the range of 2-10 nm, or 3-5 nm.

The quaternary-doped ruthenium oxide nanoparticles of the present disclosure can be synthesized by known methods such as liquid phase synthesis including sol-gel and co-precipitation, and wet impregnation methods. In some examples, the quaternary-doped ruthenium oxide nanoparticles of the present disclosure can be synthesized by a method for forming single phase multi-element oxide particles described in the co-pending U.S. application Ser. No. 19/196,842 entitled “Method for Synthesizing Multi-Element Metal Oxide Nanoparticles” filed on May 2, 2025. The method generally involves dissolving organometallic precursors of the metals, each having the formula M(acac)n in an organic solvent; impregnating the organometallic precursors on a support; reducing the organometallic precursors to obtain alloy nanoparticles on the support; and annealing the alloy nanoparticles and support to remove the support and to convert the alloy nanoparticles to oxide nanoparticles. In the formula M represents the metal, i.e., Ru, Cr, Ni, Ti, or Co; acac represents acetylacetonate, a bidentate ligand, used in the preparation of precursor solutions for catalysts nanoparticles; and n is an integer representing the number of acac ligands bound to the respective metal. The entire disclosure of the co-pending U.S. application Ser. No. 19/196,842 entitled “Method for Synthesizing Multi-Element Metal Oxide Nanoparticles” filed on May 2, 2025, which is commonly assigned and concurrently filed herewith, and is incorporated herein by reference in its entirety.

The present disclosure also relates to a water electrolyzer device comprising an anode; a cathode; a proton exchange membrane disposed between the anode and cathode; an anode collector; and a cathode collector. The oxygen evolution reaction (OER) catalysts comprising quaternary-doped ruthenium oxides of present disclosure are provided to the anode where the oxygen evolution reaction (OER) catalyst comprises the quaternary-doped ruthenium oxides of formula Ruₓ(CrNiTiCo)₁₋ₓO₂, wherein x is between 0.20-0.75. In some examples, x may be 0.75. In some examples, the quaternary-doped ruthenium dioxide of the present disclosure may comprise 20 at% Ru, 20 at% M1, 20 at% M2, 20 at% M3, and 20 at% M4, i.e., Ru_{0.2}M1_{0.2}M2_{0.2}M3_{0.2}M4_{0.2}O₂.

The present disclosure also provides a method for enhancing the electrochemical stability of oxygen evolution reaction (OER) catalysts in acidic media comprising providing an oxygen evolution reaction (OER) catalyst material to an anode of a water electrolyzer device, wherein the oxygen evolution (OER) catalyst material comprises quaternary-doped ruthenium oxide of formula Ruₓ(CrNiTiCo)₁₋ₓO₂, wherein x is between 0.20-0.75. In some examples, x is 0.75. In some examples, the quaternary-doped ruthenium oxide is Ru_{0.75}(CrNiTiCo)_{0.25}O₂.

### EXAMPLES

Various aspects of the present disclosure are further illustrated with respect to the following examples. It is to be understood that these examples are provided to illustrate specific embodiments of the present disclosure and should not be construed as limiting the scope of the present disclosure in or to any particular aspect.

### Example 1. Synthesis of Ru_{0.75}(CrNiTiCo)_{0.25}O₂ Nanoparticles

334.24 mg of Ru(acac)₃, 24.42 mg of Cr(acac)₃, 17.96 mg of Ni(acac)₂, 10.8 μl of Titanium diisopropoxide bis(acetylacetonate) 75 wt. % in isopropanol, and 24.91 mg of Co(acac)₃ were added in 150 ml isopropanol and sonicated for 2 hours. 0.4 g of Carbon black was then added and dispersed by stirring for 20 hours under room temperature. The mixture was dried by using a rotary evaporator and the remaining powder was collected.

The powder was annealed in a flowing Ar/H₂ (7% H₂) atmosphere at 800 °C for 4 hours, followed by annealing in air at 550 °C for 4 hours.

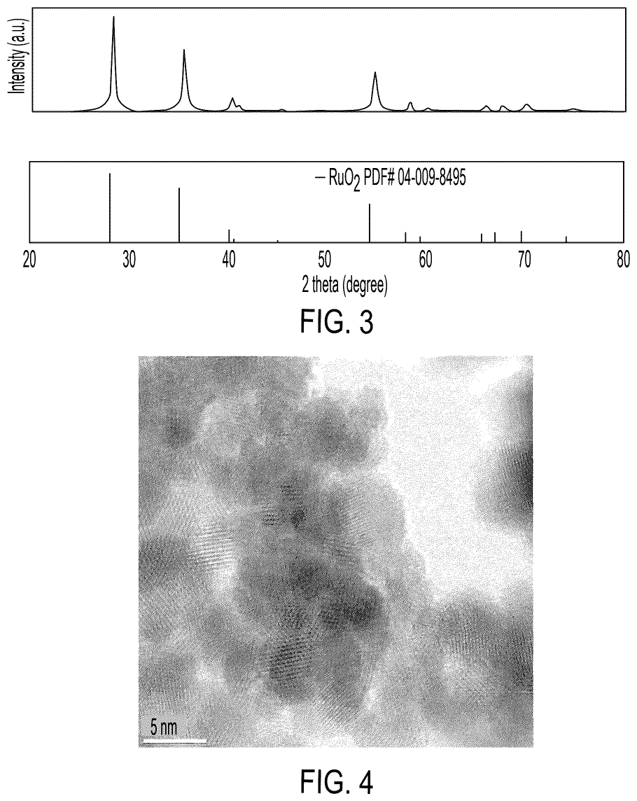

FIG. 3 demonstrates that a pure phase of tetragonal rutile-type structure was achieved in the synthesized Ru_{0.75}(CrNiTiCo)_{0.25}O₂ nanoparticles. The X-ray diffraction (XRD) peaks of synthesized Ru_{0.75}(CrNiTiCo)_{0.25}O₂ shifted to higher 2θ (2 theta) values compared to those of RuO₂, indicating the incorporation of Cr, Ni, Ti, and Co into the RuO₂ crystal lattice. For comparison, peaks from the RuO₂ standard (PDF #04-009-8495) are provided in FIG. 3.

The scanning transmission electron microscope (STEM) image in FIG. 4 displayed a crystallite structure with particle sizes of 3-5 nm and good crystallinity in the synthesized Ru_{0.75}(CrNiTiCo)_{0.25}O₂ nanoparticles.

### Example 2. Ink and Electrode Preparation

20 mg of catalyst powder was added to a mixture of 1 ml of isopropyl alcohol, 4 ml of DI water, and 100 μl of Nafion Dispersion D520 and sonicated for 1 h to obtain a well-dispersed catalyst ink. For electrode preparation, 20 μl of catalyst ink was drop-cast on a 5.0-mm diameter glassy carbon electrode, resulting in a catalyst loading of 400 μg/cm². The electrode was mounted to a rotator (Pine Instrument rotator upside down) and was rotated at a speed of 200 rpm and dried.

### Example 3. Electrochemical Measurement

The electrochemical experiments were conducted using a Pine Instrument rotating disk electrode (RDE) workstation. A three-electrode system, consisting of the catalyst film-coated glassy carbon working electrode, a platinum wire counter electrode, and a home-made Pt reference electrode (with fresh H₂ from water electrolysis for each test), were used for all electrochemical measurements. The electrolyte used was 0.1 M HClO₄. Linear sweep voltammetry (LSV) tests were performed with a scan rate 1 mV/s and a RDE rotating speed 2500 rpm in O₂ saturated 0.1 M HClO₄. Chronopotentiometry (CP) tests were conducted at 10 mA/cm².

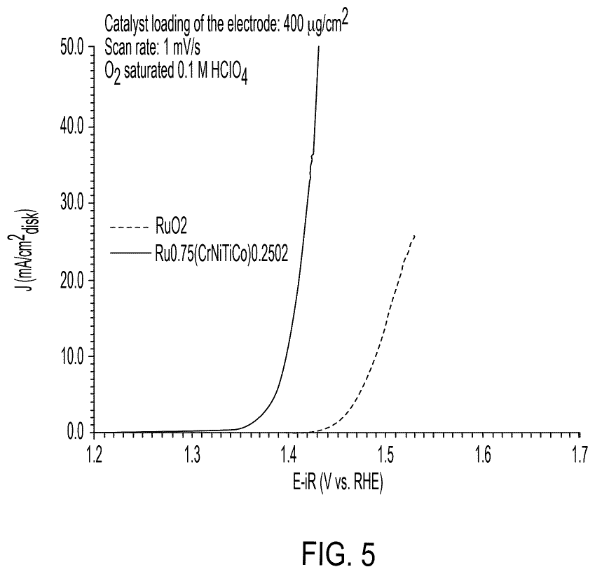

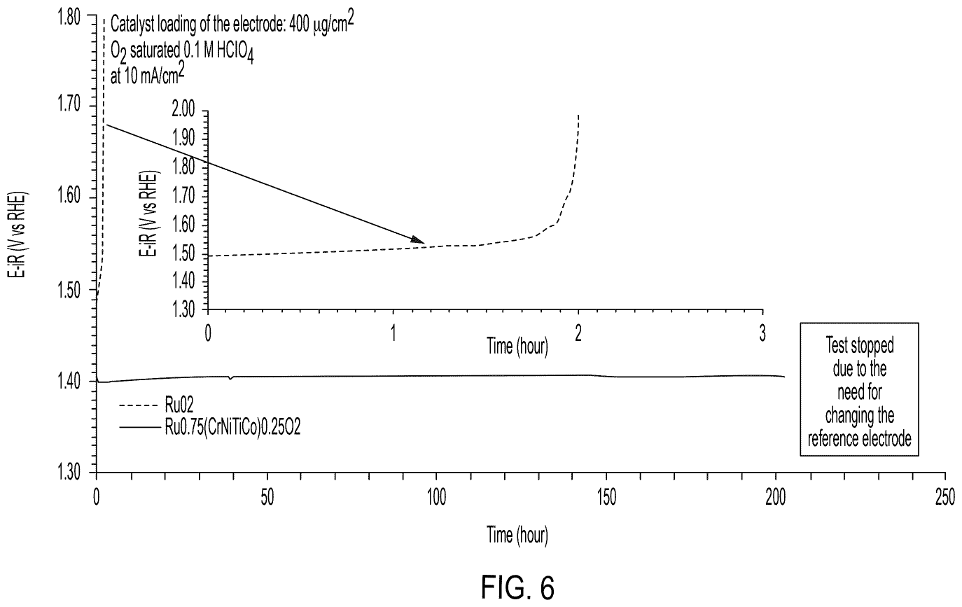

Rotating disk electrode (RDE) evaluation results are shown in FIG. 5 and FIG. 6. For comparison, RuO₂ were also evaluated using the same conditions. As can be seen in FIG. 5, the synthesized Ru_{0.75}(CrNiTiCo)_{0.25}O₂ catalyst delivered a current density of 10 mA/cm² at an overpotential of less than 170 mV in 0.1 M HClO₄. Thus, Ru_{0.75}(CrNiTiCo)_{0.25}O₂ showed increased OER activity than RuO₂.

In FIG. 6, Ru_{0.75}(CrNiTiCo)_{0.25}O₂ showed significantly enhanced OER stability. While RuO₂ degraded in less than two hours, Ru_{0.75}(CrNiTiCo)_{0.25}O₂ exhibited a low degradation rate smaller than 25 μV/h for over 200 hours of operation at 10 mA/cm². Note that the test stopped at 202 hours due to the need to change the reference electrode.

The results shown in FIG. 5 and FIG. 6 clearly demonstrate that the Ru_{0.75}(CrNiTiCo)_{0.25}O₂ catalyst exhibits superior oxygen evolution reaction (OER) performance compared to benchmark RuO₂, both in terms of activity and stability in acidic media.

The preceding description is merely illustrative in nature and is in no way intended to limit the disclosure, its application, or uses. As used herein, the phrase at least one of A, B, and C should be construed to mean a logical (A or B or C), using a non-exclusive logical “or.” It should be understood that the various steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for general organization of topics within the present disclosure, and are not intended to limit the disclosure of the technology or any aspect thereof. The recitation of multiple embodiments having stated features is not intended to exclude other embodiments having additional features, or other embodiments incorporating different combinations of the stated features.

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that an embodiment can or may comprise certain elements or features does not exclude other embodiments of the present technology that do not contain those elements or features.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one aspect, or various aspects means that a particular feature, structure, or characteristic described in connection with an embodiment or particular system is included in at least one embodiment or aspect. The appearances of the phrase “in one aspect” (or variations thereof) are not necessarily referring to the same aspect or embodiment. It should be also understood that the various method steps discussed herein do not have to be carried out in the same order as depicted, and not each method step is required in each aspect or embodiment.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations should not be regarded as a departure from the disclosure, and all such modifications are intended to be included within the scope of the disclosure.

What is claimed is:

1. An oxygen evolution reaction (OER) catalyst comprising a quaternary-doped ruthenium oxide of formula Ruₓ(CrNiTiCo)₁₋ₓO₂, wherein x is between 0.20-0.75.

2. The oxygen evolution reaction (OER) catalyst according to claim 1, wherein x is 0.75.

3. The oxygen evolution reaction (OER) catalyst according to claim 1, wherein the quaternary-doped ruthenium oxide is Ru_{0.75}(CrNiTiCo)_{0.25}O₂.

4. The oxygen evolution reaction (OER) catalyst according to claim 1, wherein the quaternary-doped ruthenium oxide crystallizes in a pure phase of tetragonal rutile-structure based on a RuO₂ crystal lattice.

5. The oxygen evolution reaction (OER) catalyst according to claim 1, which is stable in acidic media.

6. The oxygen evolution reaction (OER) catalyst according to claim 1, wherein the quaternary-doped ruthenium oxide comprises nanoparticles.

7. The oxygen evolution reaction (OER) catalyst according to claim 1, wherein the quaternary-doped ruthenium oxide comprises nanoparticles having an average particle size of 2-10 nm.

8. A water electrolyzer device comprising:
an anode;
a cathode;
a proton exchange membrane disposed between the anode and cathode;
an anode collector; and
a cathode collector,
wherein the anode comprises an oxygen evolution reaction (OER) catalyst comprising an oxygen evolution reaction (OER) catalyst a quaternary-doped ruthenium oxide of formula Ruₓ(CrNiTiCo)₁₋ₓO₂, wherein x is between 0.20-0.75.

9. The water electrolyzer device according to claim 8, wherein x is 0.75.

10. The water electrolyzer device according to claim 8, wherein the quaternary-doped ruthenium oxide is Ru_{0.75}(CrNiTiCo)_{0.25}O₂.

11. The water electrolyzer device according to claim 8, wherein the quaternary-doped ruthenium oxide crystallizes in a pure phase of tetragonal rutile-structure based on a RuO₂ crystal lattice.

12. The water electrolyzer device according to claim 11, which is stable in acidic media.

13. The water electrolyzer device according to claim 11, wherein the quaternary-doped ruthenium oxide comprises nanoparticles.

14. The water electrolyzer device according to claim 11, wherein the quaternary-doped ruthenium oxide comprises nanoparticles having an average particle size of 2-10 nm.

15. A method for enhancing electrochemical stability of oxygen evolution reaction catalysts in acidic media comprising:
providing an oxygen evolution reaction (OER) catalyst material to an anode of a water electrolyzer device, wherein the oxygen evolution reaction (OER) catalyst material comprises a quaternary ruthenium doped oxide of formula Ruₓ(CrNiTiCo)₁₋ₓO₂, wherein x is between 0.20-0.75.

16. The method according to claim 15, wherein the oxygen evolution reaction (OER) catalyst material is stable in acidic media.

17. The method according to claim 15, wherein x is 0.75.

18. The method according to claim 15, wherein the quaternary ruthenium doped oxide is Ru_{0.75}(CrNiTiCo)_{0.25}O₂.

19. The method according to claim 15, wherein the quaternary ruthenium doped oxide crystallizes in a pure phase of tetragonal rutile-structure based on a RuO₂ crystal lattice.

20. The method according to claim 15, wherein the quaternary ruthenium doped oxide comprises nanoparticles having an average particle size of 2-10 nm.
